(19) United States
(12) Patent Application Publication
(10) Pub. No.: US 2020/0251019 A1
(43) Pub. Date: Aug. 6, 2020

(54) SOLAR SYSTEM TEACHING DEVICE

(71) Applicants: Boniphace M. Rutta, Columbia, MD (US); Joyce J. Cottrell, Columbia, MD (US)

(72) Inventors: Boniphace M. Rutta, Columbia, MD (US); Joyce J. Cottrell, Columbia, MD (US)

(21) Appl. No.: 16/712,937

(22) Filed: Dec. 12, 2019

Related U.S. Application Data
(60) Provisional application No. 62/799,564, filed on Jan. 31, 2019.

(51) Int. Cl. G09B 27/02; G09B 5/00

(52) U.S. Cl. CPC G09B 27/02; G09B 5/00

(57) ABSTRACT

An educational solar system model; the educational solar system model includes a base, a central arm, a primary unit configured to represent a Sun, a support plate, a first orbiting unit and a second orbiting unit. In one version, the first orbiting unit is configured to represent Earth, and the second orbiting unit is configured to represent a Moon. The educational solar system teaches students about geography and physics including planetary rotation and revolution, yearly seasons, location of continents, oceans, and the like, time zones, and much more.

### CROSS REFERENCE TO RELATED APPLICATION

The present application is related to and claims priority to U.S. Provisional Patent Application No. 62/799,564 filed Jan. 31, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of educational devices and more specifically relates to an educational solar system model.

### 2. DESCRIPTION OF RELATED ART

Educating students about the solar system can be difficult. Standard models may be stationary and unable to rotate. Simulating rotation and revolution effects may be nearly impossible and force students to use their imagination. Students may be lacking in knowledge about geography and physics. A suitable solution is desired.

U.S. Pat. No. 3,387,393 to Clair O Musser relates to a toy planetarium. The described toy planetarium includes a base with a flat, non-magnetic top. A plurality of concentric ring gears are rotatably mounted on the base underneath the top. A single motor is loaded on the base 18, connected to a drive shaft carrying a plurality of pinion gears simultaneously rotating all of these ring gears. A member simulating a planet is located generally above each ring gear on the top of the base. Magnetic coupling means couple the members simulating planets and the corresponding ring gears so that these members are rotated as the ring gears are rotated through the operation of the motor means.

### BRIEF SUMMARY OF THE INVENTION

In view of the foregoing disadvantages inherent in the known educational device art, the present disclosure provides a novel solar system teaching device (system). The general purpose of the present disclosure, which will be described subsequently in greater detail, is to provide an educational tool designed to teach users about topics dealing with the solar system. The tool may specifically teach students about geography and physics including planetary rotation and revolution, yearly seasons, location of continents, oceans, and the like, time zones, and much more.

An educational solar system model is disclosed herein. The educational solar system model includes a base which may include at least one base drive-means. A central arm may be attached to a top surface of the base at a first end of the central arm. A primary unit may be attached to the top surface of the base about the first end of the primary arm, the primary unit may include a first spherical module configured to represent a sun. The primary unit may include a primary axis and at least one primary unit drive-means configured to rotate the first spherical module about the primary axis.

A support plate may be attached to a second end of the central arm. A first orbiting unit may be attached to the support plate, the first orbiting unit may include a second spherical module configured to represent earth. The first orbiting unit may include a first axis and at least one first orbiting drive-means configured to rotate the second spherical module about the first axis. Similarly, a second orbiting unit may be attached to the support plate opposite the first orbiting unit, the second orbiting unit may include a third spherical module configured to represent a moon. The second orbiting unit may include a second axis and at least one second orbiting drive-means configured to rotate the third spherical module about the second axis.

Further, a power inlet may be included, and an electrical-circuit disposed within the base. In addition, the at least one base-drive means may be configured to revolve the first orbiting unit and the second orbiting unit around the central axis via the central arm.

A method of using the educational solar system model is also disclosed herein. The method of using educational solar system model may comprise the steps of providing the educational solar system model as above; connecting the educational solar system model to dc power (or other suitable powering means) via the power inlet; watching rotation and revolution of the primary unit, the first orbiting unit, and the second orbiting unit; and providing education based on the educational solar system model.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a solar system teaching device, constructed and operative according to the teachings of the present disclosure.

FIG. 1 is a side perspective view of the educational solar system model during an ‘in-use’ condition, according to an embodiment of the disclosure.

FIG. 2 is a side perspective view of the educational solar system model of FIG. 1, according to an embodiment of the present disclosure.

FIG. 3A is a side perspective view of the educational solar system model of FIG. 1, according to an embodiment of the present disclosure.

FIG. 3B is a side perspective view of the educational solar system model of FIG. 1, according to an embodiment of the present disclosure.

FIG. 4 is a side perspective view of the educational solar system model of FIG. 1, according to an embodiment of the present disclosure.

FIG. 5 is a flow diagram illustrating a method of use for the educational solar system model, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an educational device and more particularly to a solar system teaching device as used to improve the practical and theoretical education of students.

Generally, disclosed is a teaching tool used to educate students about the solar system. The system can be easily assembled and disassembled for storage and transportation. The entire tool may be comprised of a solid, durable base, central arm supports, a central bulb functioning as a Sun, covers, and a DC motor. The base may be attached to the arm support via gears, pulleys, and rollers. The central arm is intended to be rotated around the central bulb. The motor may connect to the central arm and operate off as little as 3.7 v of DC power. The motor may be operated via a remote control or an on/off switch.

Bulbs representing a Moon and Earth on the central arm may rotate around the sun, and rotate on their own axis (simultaneously), simulating planetary rotation and revolution, and solar and lunar eclipses. The tool may be multifunctional and offers numerous methods of education about the solar system.

The tool may be used to demonstrate: space universe, sun, planets' motions especially earth's rotation & revolution, four seasons of the year (spring, summer, autumn and winter), lunar & solar eclipse, earth's globe (shape, size and location of the continents, oceans, latitudes [equator] and longitudes [Greenwich], inclination, moon and its motion, stars, constellations, galaxy, comets, asteroids, meteors, satellites, tides, time zone, etc. In physics: it can cover mechanics (circular motion [universal gravitational force, centripetal force, angular velocity], pulleys and friction), electromagnetism—current electricity and motors. It also covers light and some electronics concepts. Exact specifications may vary upon further development and manufacturing.

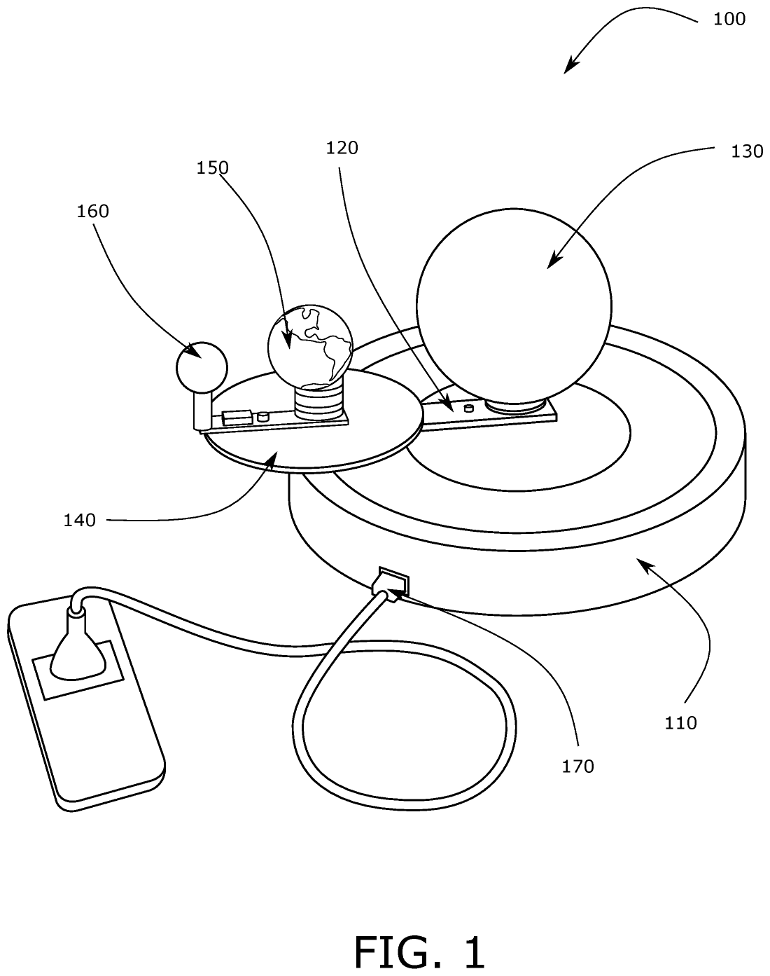

Referring now more specifically to the drawings by numerals of reference, there is shown in FIGS. 1-4, various views of an educational solar system model 100.

FIG. 1 shows an educational solar system model 100 during an ‘in-use’ condition 150, according to an embodiment of the present disclosure. As Illustrated, the educational solar system model 100 may include a base 110, a central arm 120, a primary unit 130, a support plate 140, a first orbiting unit 150, a second orbiting unit 160, a power inlet 170 and an electrical-circuit. The central arm 120, the primary unit 130, the support plate 140, the first orbiting unit 150 and the second orbiting unit 160 may be removable from the base 110 for easy portability and storage.

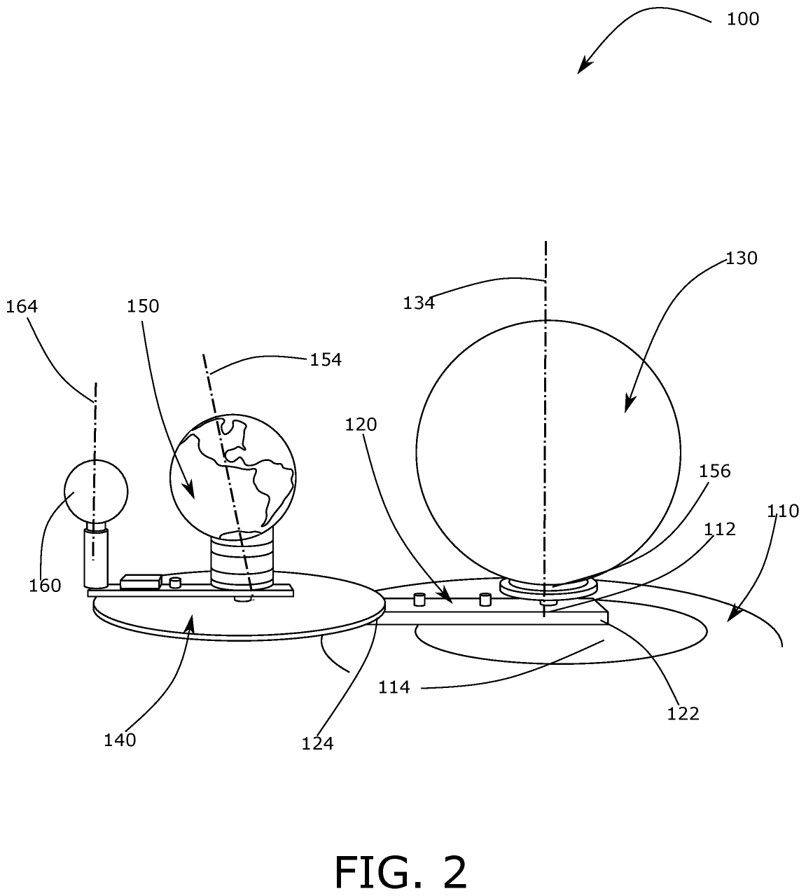

FIG. 2 shows a side perspective view of the educational solar system model 100 of FIG. 1, according to an embodiment of the present disclosure. The base 110 may include at least one base drive-means 112. The at least one base drive-means 112 may include one of, some of, or all of at least one motor, at least one gear, and at least one pulley. The central arm 120 may be attached to a top surface 114 of the base 110 at a first end 122 of the central arm 120.

The primary unit 130 may be attached to the top surface 114 of the base 110 about the first end 122 of the central arm 120, the primary unit 130 including a first spherical module configured to represent a sun. The primary unit 130 may include a primary axis 134 and at least one primary unit drive-means 136 configured to rotate the first spherical module about the primary axis 134. The at least one primary unit drive-means 136 may include one of, some of, or all of at least one motor, at least one gear, and at least one pulley.

As shown, the support plate 140 may be attached to a second end 124 of the central arm 120. The first orbiting unit 150 may be attached to the support plate 140 and may include a second spherical module configured to represent earth. The first orbiting unit 150 may include a first axis 154. Preferably, the first axis 154 may be tilted at an angle equal to a tilt angle of the Earth. In one embodiment, the first axis 154 may be tilted at an angle of at least 23 degrees. Similarly, the second orbiting unit 160 may be attached to the support plate 140 opposite the first orbiting unit 150. The second orbiting unit 160 may include a third spherical module configured to represent a moon and may include a second axis 164. The at least one base-drive means 112 may be configured to revolve the first orbiting unit 150 and the second orbiting unit 160 around the primary axis 134 via the central arm 120.

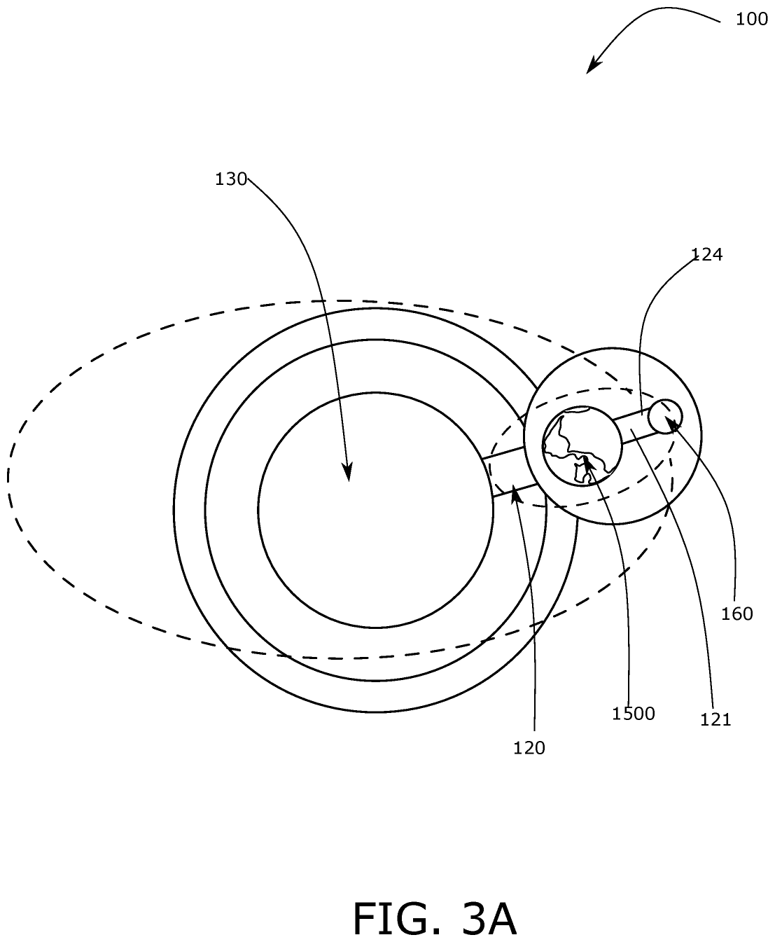

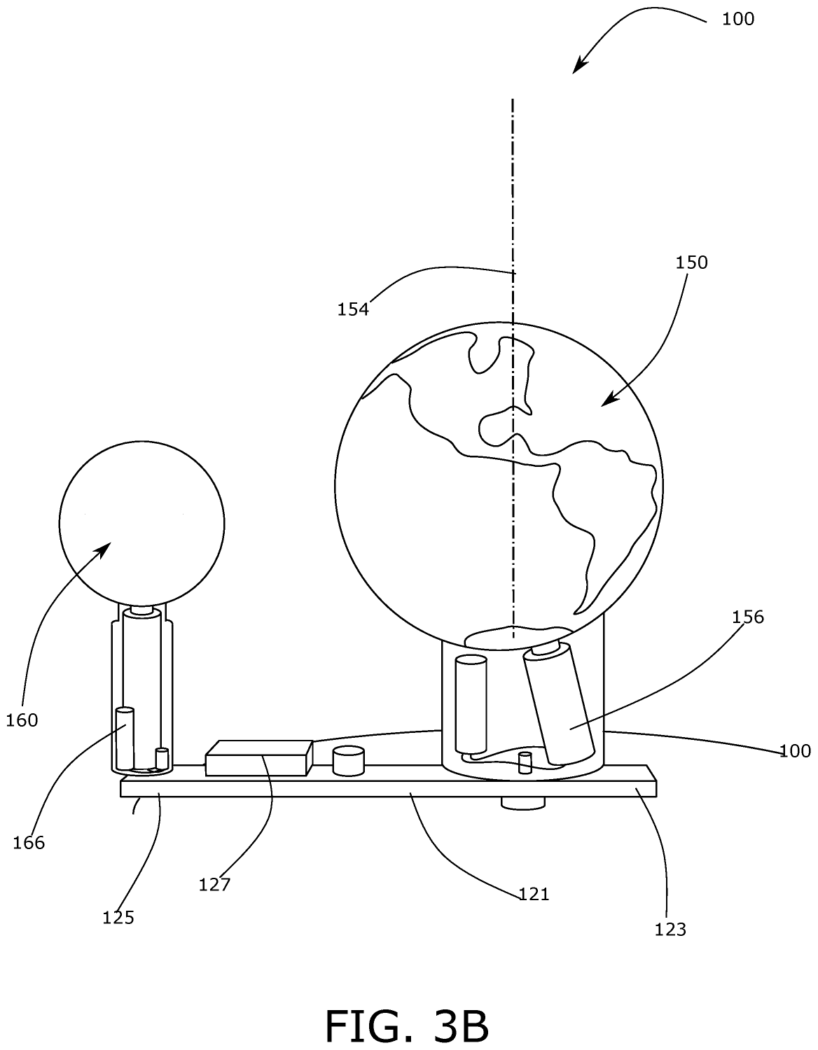

FIGS. 3A-3B shows side perspective views of the educational solar system model 100 of FIG. 1, according to an embodiment of the present disclosure. The first orbiting unit 150 may include at least one first orbiting drive-means 156, the at least one first orbiting drive-means 156 configured to rotate the second spherical module about the first axis 154. Likewise, the second orbiting unit 160 may include at least one second orbiting drive-means 166 configured to rotate the third spherical module about the second axis 164. The first orbiting drive-means 156 and the second orbiting drive-means 166 may each include one of, some of, or all of at least one motor, at least one gear, and at least one pulley.

The central arm 120 may include at least one central arm drive-means 126 may be configured to extend the second end 124 of the central arm 120 in a reciprocating motion. Further, the central arm 120 may include a first telescopic length, and the at least one central arm 120 drive means may be configured to extend the first telescopic length in the reciprocating motion.

Further, a reciprocating arm 121 may be attached to the support plate 140. The reciprocating arm 121 may include a first reciprocating arm end 123 and a second reciprocating arm end 125, and as shown, the first orbiting unit 150 may be located at the first reciprocating arm end 123, and the second orbiting unit 160 may be located at the second reciprocating arm end 125. The reciprocating arm 121 may include at least one reciprocating arm drive-means 127 which may be configured to extend the second reciprocating arm end 125 in a reciprocating motion. The reciprocating arm 121 may include a second telescopic length, and the at least one reciprocating arm drive means 127 may be configured to extend the second telescopic length in a reciprocating motion.

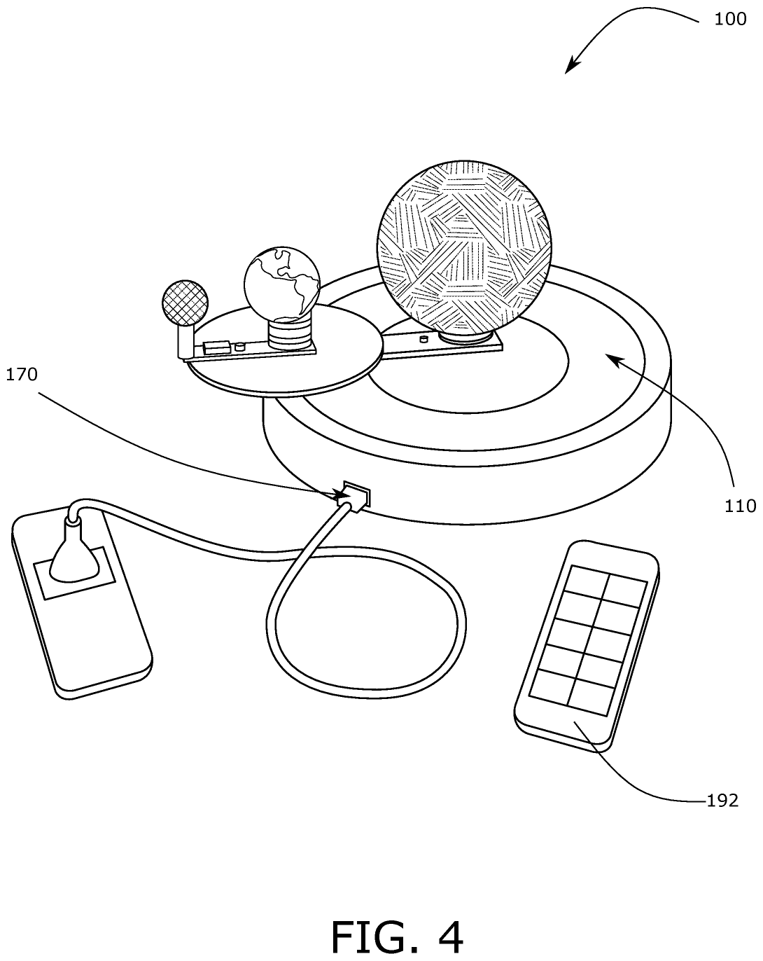

FIG. 4 shows a side perspective view of the educational solar system model 100 of FIG. 1, according to an embodiment of the present disclosure. The educational solar system model 100 may be powered by DC power via the power inlet 170. Preferably, the educational solar system model 100 may be powered via at least 3.7 v of DC power via the power inlet 170. This may be particularly useful for areas where electricity is less powerful or hard to come by. The electrical-circuit may be disposed within the base 110. Further, an on/off switch may be located on the base 110 and electrically connected to the electrical-circuit and configured to selectively break a continuity of the electrical circuit, to switch off the power from the power inlet 170. AC or other suitable powering means may also be used.

The educational solar system model 100 may further include a remote-control system 190. The remote-control system 190 may include a receiver disposed within the base 110 and in communication with the electrical-circuit, and a remote device 192 having a transmitter configured to transmit a command to the receiver. In one embodiment, the remote-control system 190 may use infrared technology. In another embodiment, the remote-control system 190 may use radio-frequency technology.

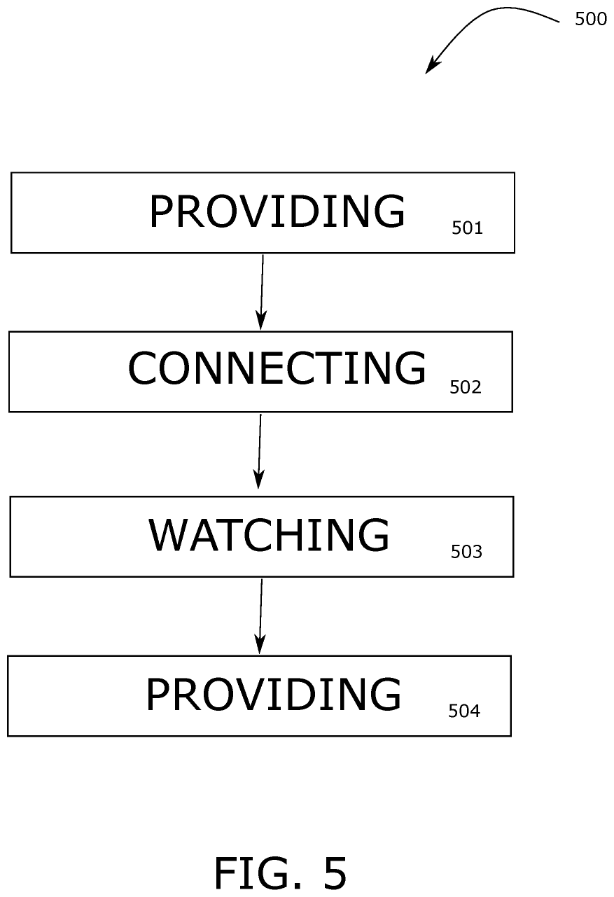

FIG. 5 is a flow diagram illustrating a method of using an educational solar system model 500, according to an embodiment of the present disclosure. As illustrated, the method of using an educational solar system model 500 may include the steps of: providing 501 the educational solar system model as above; connecting 502 the educational solar system model to dc power via the power inlet; watching 503 rotation and revolution of the primary unit, the first orbiting unit, and the second orbiting unit; and providing 504 education based on the educational solar system model.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for educational solar system model 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An educational solar system model comprising:
a base including at least one base drive-means;
a central arm attached to a top surface of the base at a first end of the central arm;
a primary unit attached to the top surface of the base about the first end of the central arm, the primary unit including a first spherical module configured to represent a sun, the primary unit including a primary axis, the primary unit further including at least one primary unit drive-means, the at least one primary unit drive-means configured to rotate the first spherical module about the primary axis;
a support plate attached to a second end of the central arm;
a first orbiting unit attached to the support plate, the first orbiting unit including a second spherical module configured to represent earth, the first orbiting unit including a first axis, the first orbiting unit further including at least one first orbiting drive-means, the at least one first orbiting drive-means configured to rotate the second spherical module about the first axis;
a second orbiting unit attached to the support plate opposite the first orbiting unit, the second orbiting unit including a third spherical module configured to represent a moon, the second orbiting unit including a second axis, the second orbiting unit further including at least one second orbiting drive-means, the at least one second orbiting drive-means configured to rotate the third spherical module about the second axis;
a power inlet; and
an electrical-circuit disposed within the base; and
wherein the at least one base-drive means is configured to revolve the first orbiting unit and the second orbiting unit around the central axis via the central arm.

2. The educational solar system model of claim 1, wherein the central arm includes at least one central arm drive-means configured to extend the second end of the central arm in a reciprocating motion.

3. The educational solar system model of claim 2, wherein the central arm includes a first telescopic length, and wherein the at least one central arm drive means is configured to extend the first telescopic length in the reciprocating motion.

4. The educational solar system model of claim 1, further comprising a reciprocating arm attached to the support plate.

5. The educational solar system model of claim 4, wherein the reciprocating arm includes a first reciprocating arm end and a second reciprocating arm end.

6. The educational solar system model of claim 5, wherein the first orbiting unit is located at the first reciprocating arm end, and the second orbiting unit is located at the second reciprocating arm end.

7. The educational solar system model of claim 4, wherein the reciprocating arm includes at least one reciprocating arm drive-means configured to extend the second reciprocating arm end in a reciprocating motion.

8. The educational solar system model of claim 4, wherein the reciprocating arm includes a second telescopic length, and wherein the at least one reciprocating arm drive means is configured to extend the second telescopic length in a reciprocating motion.

9. The educational solar system model of claim 1, wherein the educational solar system model is powered by DC power via the power inlet.

10. The educational solar system model of claim 9, wherein the educational solar system model is powered via at least 3.7 v of DC power via the power inlet.

11. The educational solar system model of claim 1, further comprising an on/off switch electrically connected to the electrical-circuit and configured to selectively break a continuity of the electrical circuit.

12. The educational solar system model of claim 1, further comprising a remote-control system.

13. The educational solar system model of claim 12, wherein the remote-control system includes a receiver disposed within the base and in communication with the electrical-circuit, and a remote device having a transmitter configured to transmit a command to the receiver.

14. The educational solar system model of claim 13, wherein the remote-control system uses infrared technology.

15. The educational solar system model of claim 13, wherein the remote-control system uses radio-frequency technology.

16. The educational solar system model of claim 1, wherein the central arm, the primary unit, the support plate, the first orbiting unit and the second orbiting unit are removable from the base for easy portability and storage.

17. The educational solar system model of claim 1, wherein the first axis is tilted at an angle equal to a tilt angle of the Earth.

18. The educational solar system model of claim 17, wherein the first axis is tilted at an angle of at least 23 degrees.

19. An educational solar system model comprising:
a base including at least one base drive-means;
a central arm attached to a top surface of the base at a first end of the central arm;
a primary unit attached to the top surface of the base about the first end of the primary arm, the primary unit including a first spherical module configured to represent a sun, the primary unit including a primary axis, the primary unit further including at least one primary unit drive-means, the at least one primary unit drive-means configured to rotate the first spherical module about the primary axis;
a support plate attached to a second end of the central arm;
a first orbiting unit attached to the support plate, the first orbiting unit including a second spherical module configured to represent earth, the first orbiting unit including a first axis, the first orbiting unit further including at least one first orbiting drive-means, the at least one first orbiting drive-means configured to rotate the second spherical module about the first axis;
a second orbiting unit attached to the support plate opposite the first orbiting unit, the second orbiting unit including a third spherical module configured to represent a moon, the second orbiting unit including a second axis, the second orbiting unit further including at least one second orbiting drive-means, the at least one second orbiting drive-means configured to rotate the third spherical module about the second axis;
a power inlet;
an electrical-circuit disposed within the base;
an on/off switch electrically connected to the electrical-circuit and configured to selectively break a continuity of the electrical circuit; and
a remote-control system; and
wherein the at least one base-drive means is configured to revolve the first orbiting unit and the second orbiting unit around the central axis via the central arm;
wherein the central arm includes a first telescopic length, and wherein the at least one central arm drive means is configured to extend the first telescopic length in a reciprocating motion;
further comprising reciprocating arm attached to the support plate;
wherein the reciprocating arm includes a first reciprocating arm end and a second reciprocating arm end;
wherein the first orbiting unit is located at the first reciprocating arm end, and the second orbiting unit is located at the second reciprocating arm end;
wherein the reciprocating arm includes a second telescopic length, and wherein the at least one reciprocating arm drive means is configured to extend the second telescopic length in another reciprocating motion;
wherein the educational solar system model is powered by DC power via the power inlet;
wherein the educational solar system model is powered via at least 3.7 v of DC power via the power inlet;
wherein the remote-control system includes a receiver disposed within the base and in communication with the electrical-circuit, and a remote device having a transmitter configured to transmit a command to the receiver;
wherein central arm, the primary unit, the support plate, the first orbiting unit and the second orbiting unit are removable from the base for easy portability and storage; and
wherein the first axis is tilted at an angle equal to a tilt angle of Earth.

20. A method of using an educational solar system model, the method comprising the steps of:
providing the educational solar system model including:
a base including at least one base drive-means;
a central arm attached to a top surface of the base at a first end of the central arm;
a primary unit attached to the top surface of the base about the first end of the primary arm, the primary unit including a first spherical module configured to represent a sun, the primary unit including a primary axis, the primary unit further including at least one primary unit drive-means, the at least one primary unit drive-means configured to rotate the first spherical module about the primary axis;
a support plate attached to a second end of the central arm;
a first orbiting unit attached to the support plate, the first orbiting unit including a second spherical module configured to represent earth, the first orbiting unit including a first axis, the first orbiting unit further including at least one first orbiting drive-means, the at least one first orbiting drive-means configured to rotate the second spherical module about the first axis;
a second orbiting unit attached to the support plate opposite the first orbiting unit, the second orbiting unit including a third spherical module configured to represent a moon, the second orbiting unit including a second axis, the second orbiting unit further including at least one second orbiting drive-means, the at least one second orbiting drive-means configured to rotate the third spherical module about the second axis;
a power inlet; and
an electrical-circuit disposed within the base;
connecting the educational solar system model to dc power via the power inlet;
watching rotation and revolution of the primary unit, the first orbiting unit, and the second orbiting unit; and
providing education based on the educational solar system model.
